(19) United States
(12) Patent Application Publication
(10) Pub. No.: US 2013/0334392 A1
(43) Pub. Date: Dec. 19, 2013

(54) L-SHAPED BRACKET WITH ALIGNMENT ASSISTING PEEP HOLE

(71) Applicant: Oz-Post International, LLC, Richardson, TX (US)

(72) Inventor: Ian A. Hill, Plano, TX (US)

(21) Appl. No.: 13/918,179

(22) Filed: Jun. 14, 2013

Related U.S. Application Data
(60) Provisional application No. 61/660,400, filed on Jun. 15, 2012.

(51) Int. Cl. F16M 13/00

(52) U.S. Cl. CPC F16M 13/00
USPC 248/500

(57) ABSTRACT

An L-shaped bracket includes a first leg and a second leg. The first leg is joined to the second leg at a bending-point. A first opening is formed in the first leg and a second opening is formed in the second leg. The first and second openings are each configured as a mounting opening to receive a mounting device for securing the L-shaped bracket to one or more structural members. The U-shaped bracket further includes a third opening formed at the bending point. The third opening is laterally centered between side edges of the bracket and is configured as a sighting opening allowing an installer to center the L-shaped bracket with respect to a centering mark made on the one or more structural members.

### PRIORITY CLAIM

This application claims priority from U.S. Provisional Application for Pat. No. 61/660,400 filed Jun. 15, 2012, the disclosure of which is incorporated by reference.

### BACKGROUND OF THE INVENTION

1. Technical Field of the Invention

The present invention relates generally to an L-shaped bracket for making a connection between two structural members.

2. Description of Related Art

L-shaped brackets are well known in the art. The bracket is generally formed from a strip of metal material bent at a mid-point to define a first leg and second leg oriented at a desired angle relative to each other. Conventionally, that angle is ninety degrees, although L-shaped brackets with other selected angles, both acute and obtuse, are known in the art for use in special applications. Each leg of the L-shaped bracket includes at least one mounting opening configured to pass through the strip material and sized to receive a mounting device such as a screw or bolt. In use, the first leg of the bracket is positioned on a surface of a first structural member and the mounting device is passed through the mounting opening and driven into the first structural member to secure the bracket to the first structural member. The second leg of the bracket is positioned on a surface of a second structural member and another mounting device is passed through the mounting opening and driven into the second structural member o secure the bracket to the second structural member. The L-shaped bracket accordingly functions to secure the first structural member to the second structural member.

It can be a challenge, especially for those not trained with carpentry skills, to ensure alignment of the U-shaped bracket relative to both the first and second structural members. Alignment issues concern ensuring proper flush positioning of a leg of the bracket to an edge of the structural member and further ensuring that the bracket is perpendicular to the edge of the structural member. Alignment issues still further concern ensuring proper location positioning along the length of the structural member.

What is needed is an L-shaped bracket that is easy to properly position and align.

### SUMMARY

in accordance with an embodiment, an L-shaped bracket comprises: a first leg; a second leg joined to the first leg at a bending-point; a first opening formed in the first leg; a second opening formed in the second leg; and a third opening formed at the bending point; wherein the third opening is laterally centered between side edges of the bracket.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIGS. 1A and 1B are perspective views of an L-shaped bracket;

FIGS. 2A and 2B are plan views of the legs of the bracket shown in FIGS. 1A and 1B;

FIGS. 3A and 3B show use of the L-shaped bracket of FIGS. 1A and 1B as a rafter clip;

FIG. 4 shows use of an L-shaped bracket with a different ornamental design as a rafter clip.

### DETAILED DESCRIPTION OF THE DRAWINGS

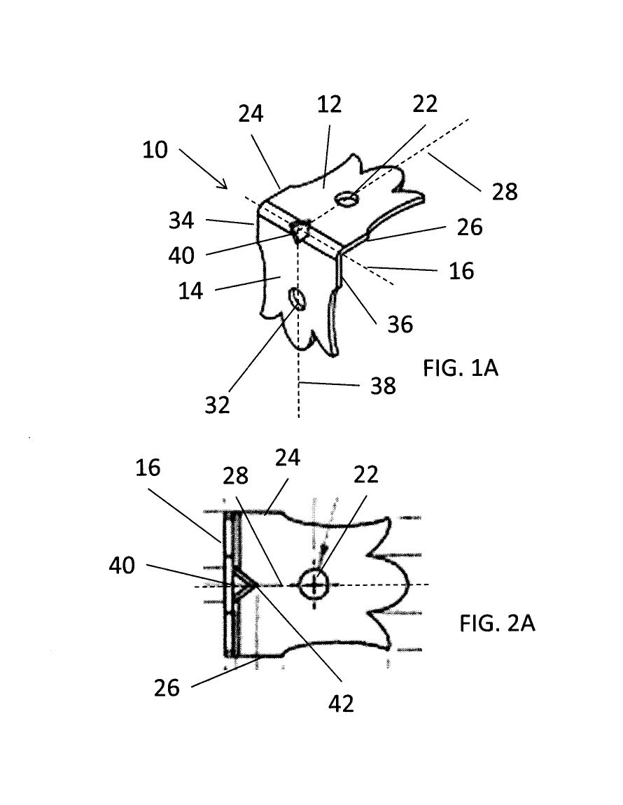

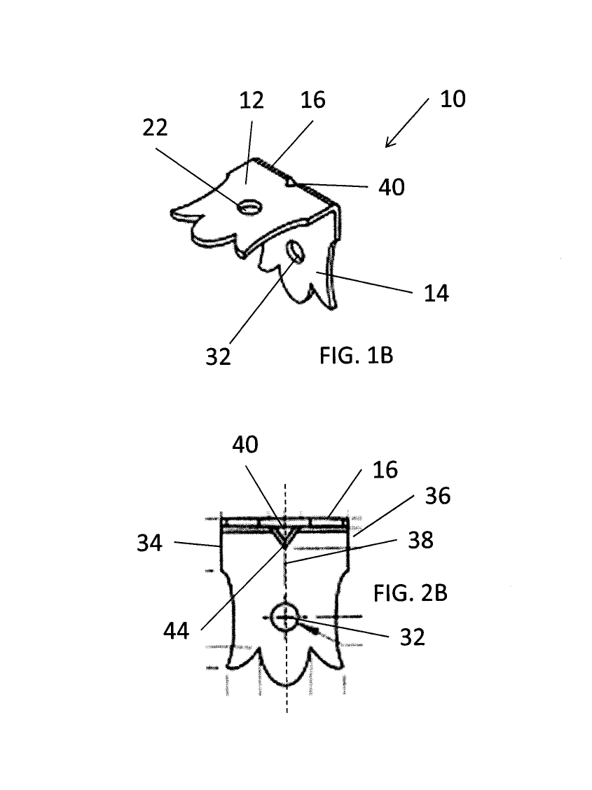

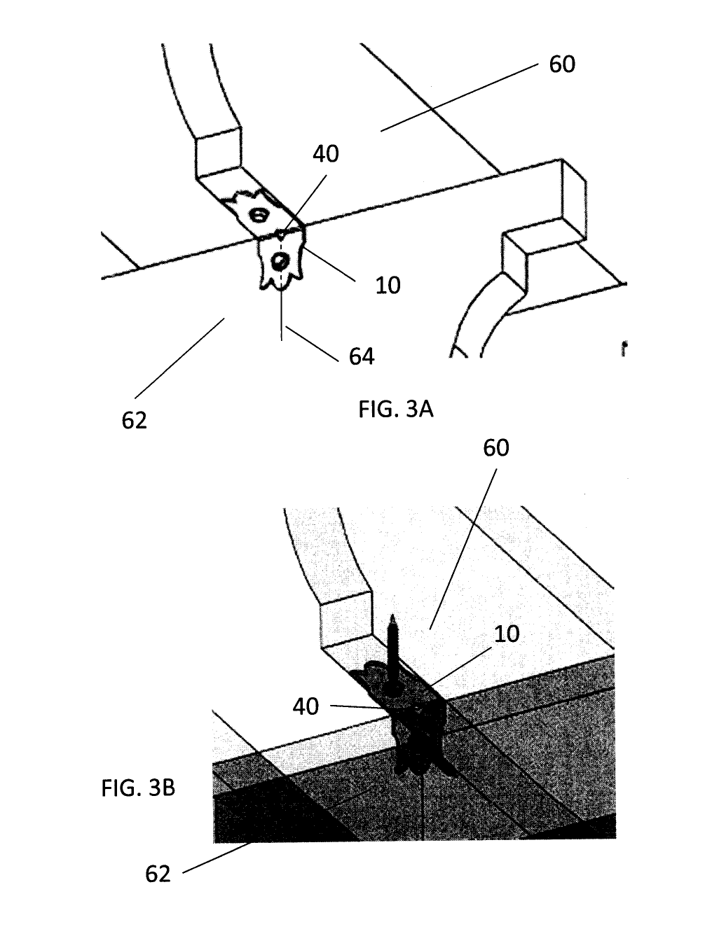

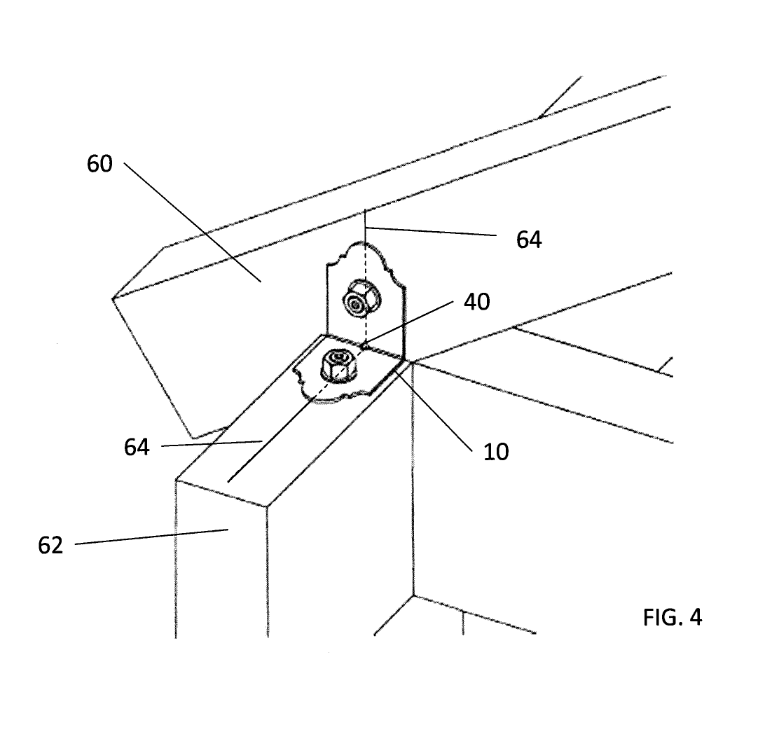

Reference is now made to FIGS. 1A and 1B which illustrate perspective views of an embodiment for an L-shaped bracket 10, and FIGS. 2A and 2B which illustrate plan views of individual legs of the bracket 10. The bracket 10 is useful in making a connection between two structural members. Examples of such structural connections are shown in FIGS. 3A, 3B and 4.

The L-shaped bracket 10 is formed from metal material that is either bent, cast or forged to define a first leg 12 and second leg 14 that are joined at a bending-point 16. The first leg 12 and second leg 14 extend longitudinally away from the bending-point 16 and are oriented at a desired angle relative to each other. Conventionally, that angle is ninety degrees. It will be understood, however, that the L-shaped bracket 10 may have any selected angle, either acute or obtuse, defined between the first leg 12 and second leg 14. Furthermore, although the bending-point 16 is shown to provide legs 12 and 14 of substantially equal length, it will be understood that the location of the bending-point may be selected as desired so as to provide legs 12 and 14 with unequal lengths. Still further, although the bending point is oriented perpendicular to side edges of the bracket, it will be understood that the orientation angle of the bending-point may be selected as desired so as to provide a bracket with uniquely oriented, for example, compound angled, legs for specific attachment applications.

The first leg 12 includes at least one opening 22 passing through the leg material. The opening 22 is positioned laterally centered between the side edges 24 and 26 of the first leg. If more than one opening 22 is provided in first leg 12, the included openings 22 may all be positioned centered between the side edges 24 and 26 of the first leg. Alternatively, one or more of the included openings 22 may be positioned laterally offset from a center ne 28 extending longitudinally along the length of the first leg 12.

The second leg 14 includes at least one opening 32 passing through the leg material. The opening 32 is positioned laterally centered between the side edges 34 and 36 of the second leg. If more than one opening 32 is provided in second leg 14, the included openings 32 may all be positioned centered between the side edges 34 and 36 of the second leg. Alternatively, one or more of the included openings 32 may be positioned offset from a center line 38 extending longitudinally along the length of the second leg 14.

In a preferred implementation, the side edges 24 and 26 of the first leg correspond with the side edges 34 and 36 of the second leg. It will, of course, be understood that in some implementations the first leg may need to be wider than the second leg, and thus the side edges 24 and 26 of the first leg will not necessarily correspond with the side edges 34 and 36 of the second leg.

In a preferred implementation, the center line 28 of the first leg 12 corresponds with the center line 38 of the second leg 14.

The bracket 10 further includes a peep hole 40 formed in the bracket at the bending-point 16. A center of the peep hole 40 is aligned with the center line 28 of the first leg 12 and/or with the center line 38 of the second leg 14. Thus, a center of the peep hole is aligned. with a lateral center between side edges of the bracket at the bending-point, and the center of the peep hole is longitudinally aligned with each of the openings 22 and 32.

The peep hole 40 has a diamond shape formed to include a first V-shaped notch 42 in the first leg 12 and a second V-shaped notch 44 in the second leg 14. The first V-shaped notch is a minor of the second V-shaped notch, and thus the back-to-back V-shaped notches define the diamond shape. An apex of the first V-shaped notch 42 is aligned with the center line 28 of the first leg 12 and thus is aligned with the center of the opening 22. An apex of the second V-shaped notch 44 is aligned with the center line 38 of the second leg 14 and thus is aligned with the center of the opening 32. More generally, the apex of the V-shaped notches 42 and 44 is aligned with a lateral center of the bracket 10 between side edges 24, 26. 34 and 36 of the bracket at the bending-point 16.

Using the peep hole 40, and in particular the apexes of the first and second V-shaped notches 42 and 44 of the peep hole 40, a person installing the bracket 10 may properly align the bracket. For example, the person may sight through the peep hole 40 to find an alignment mark placed on the structural member to which the bracket is being installed. in another example, the person may sight through the peep hole 40 and ensure that the alignment mark placed on the structural member to which the bracket is being installed passes through one of the apexes of the first and second V-shaped notches 42 and 44. In yet another example, the person may sight through the peep hole 40 and one of the openings 22 and 32 to find an alignment mark placed on the structural member to Which the bracket is being installed. In a still further example, the person may sight through the peep hole 40 and one of the openings 22 and 32 and ensure that the alignment mark placed on the structural member to which the bracket is being installed passes through one of the apexes of the first and second V-shaped notches 42 and 44 and one of the openings 22 and 32.

An end of each leg 12 and 14 may be formed to include any desired ornamental design, for example, as shown in FIGS. 1A, 1B, 2A, 2B, 3A and 3C as compared to FIG. 4. Still further, each side edge 24, 26, 34 and 36 of each leg 12 and 14 may be formed to include any desired ornamental design, for example, as shown in FIGS. 1A, 1B, 2A, 2B, 3A and 3C as compared to FIG. 4.

Although the bracket 10 is preferably made of galvanized sheet metal, it will be understood that the bracket could instead be made of plastic or stainless steel for other applications. The bracket 10 is preferably powder coated.

Reference is now made to FIGS. 3A and 3B which illustrate use of the L-shaped bracket 10 of FIGS. 1A and 1B as a rafter clip. In this implementation, the L-shaped bracket 10 is used to secure a rafter member 60 to a horizontal support member 62. The rafter member 60 is oriented perpendicular to the horizontal support member 62. A lower surface of the rafter member 60 rests on an upper surface of the horizontal support member 62. The first leg 12 of the U-shaped bracket 10 is secured by a mounting device passing through opening 22 to the lower surface of the rafter member 60. The second leg 14 of the L-shaped bracket 10 is secured by a mounting device passing through opening 32 to a side surface of the horizontal support member 62. FIG. 3B shows the rafter member 60 and support member 62 in phantom shading to permit the mounting device, comprising a screw or lag bolt in this ease, to be visible. An alignment mark 64 has been made on the side surface of the horizontal support member 62. Using at least the peep hole 40, a person can accurately align the bracket 10 with the alignment mark 64 and ensure that the bracket is properly positioned to support the rafter member 60 with a desired spacing.

Reference is now made to FIG. 4 which illustrates use of the L-shaped bracket 10 of FIGS. 1A and 1B as a rafter clip. The bracket 10 in FIG. 4 has a similar structural configuration as that shown in FIGS. 3A and 3B, but has a different ornamental design at each end of the legs 12 and 14. The installation in FIG. 4 differs from that shown in FIGS. 3A and 3B in that the bracket 10 is installed above the horizontal support member 62, with the first leg 12 of the L-shaped bracket 10 secured by a mounting device passing through opening 22 to the upper surface of the horizontal support member 62 and the second leg 14 of the L-shaped bracket 10 secured by a mounting device passing through opening 32 to a side surface of the rafter member 60. An alignment mark 64 has been made on both the upper surface of the horizontal support member 62 and the side surface of the rafter member 60. Using at least the peep hole 40, a person can accurately align the bracket 10 with one or more of the alignment marks 64 and ensure that the bracket is properly positioned.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. An L-shaped bracket with a peep hole located at a bending-point of the bracket.

2. The L-shaped bracket of claim 1, wherein the bracket includes a first leg and second leg extending away from the bending-point.

3. The L-shaped bracket of claim 2, wherein at least one of the first and second leg includes a mounting opening.

4. The L-shaped bracket of claim 3, wherein the mounting opening is longitudinally aligned with the peep hole.

5. The L-shaped bracket of claim 4, wherein the mounting opening and peep hole are laterally centered between side edges of the bracket.

6. The L-shaped bracket of claim 5, wherein the peep hole has an opening shape including at least one V-shaped notch.

7. The L-shaped bracket of claim 6, wherein an apex of the V-shaped notch is aligned with a lateral center between side edges of the bracket at the bending-point.

8. The L-shaped bracket of claim 1, wherein the peep hole is laterally centered between side edges of the bracket.

9. The L-shaped bracket of claim 8, wherein the peep hole has an opening shape including at least one V-shaped notch.

10. The L-shaped bracket of claim 9, wherein an apex of the V-shaped notch is aligned with a lateral center between side edges of the bracket at the bending-point.

11. An L-shaped bracket, comprising:
a first leg;
a second leg joined to the first leg at a bending-point;
a first opening formed in the first leg;
a second opening formed in the second leg; and
a third opening formed at the bending point;
wherein the third opening is laterally centered between side edges of the bracket.

12. The L-shaped bracket of claim 11, wherein the first and second openings are laterally centered between side edges of the bracket.

13. The L-shaped bracket of claim 11, wherein third opening has a diamond shape formed by back-to-back first and second V-shaped notches.

14. The L-shaped bracket of claim 13, wherein an apex of each first and second V-shaped notch is laterally centered between side edges of the bracket.
